(19) United States
(12) Patent Application Publication
(10) Pub. No.: US 2011/0089896 A1
(43) Pub. Date: Apr. 21, 2011

(54) Device For Recharding A Storage System Comprising Two Storage Elements And Associated Methods For Using Such A Recharging Device

(75) Inventor: Antoine Grivaux, Paris (FR)

(73) Assignee: PEUGEOT CITROEN AUTOMOBILES SA, Velizy Villacoublay (FR)

(21) Appl. No.: 12/999,053

(22) PCT Filed: Jun. 25, 2009
(86) PCT No.: PCT/FR09/51219

§ 371 Date: Dec. 14, 2010

(30) Foreign Application Priority Data
Jun. 27, 2008 (FR) 0854352

(51) Int. Cl. H02J 7/04

(52) U.S. Cl. 320/110

(57) ABSTRACT

The present invention relates essentially to a recharging device of a storage system for electric power from a power network, said storage system being used as a power source for electric or hybrid vehicle, said system comprising:
a first storage element of electrical energy (1), specifically a battery, and a second storage element of electrical energy (2), specifically a pack of supercapacitors,
a DC-DC power converter (3) being arranged between said first element and second element, said first element having a first voltage, and said second element having a second voltage which may exceed said first voltage, wherein said device comprises:
a voltage rectifying device (5) connected on the one hand by an electrical connection to the converter (3) on the side where it is connected to the second element, and also connected by a removable electrical connection to the network supply, said device being adapted to rectify the alternating voltage delivered by the network to a DC voltage in the range of operation of said converter, and also
control means (4, 6) for controlling the charge current of said second element, said control means being arranged between the converter (3) and the second element (2).

### CROSS-REFERENCE TO RELATED APPLICATIONS

The present application is the US national stage under 35 U.S.C. §371 of International Application No. PCT/FR2009/051219 which was filed on Jun. 25, 2009 and which claims the priority of French application 0854352 filed on Jun. 27, 2008.

### BACKGROUND

The present invention relates to a recharging device for a storage system comprising a first storage element such as a battery of electrochemical accumulators and a second storage element such as a supercapacitor that are rechargeable starting from a power supply source such as the domestic grid EDF (Electrical Distribution Network France) and a method for using this device.

The specific goal of the present invention is to reduce the manufacturing cost and to simplify the recharging device intended for recharging the batteries of a hybrid or all electrical vehicle.

Hybrid or all electrical vehicles containing at least one electrical storage element are already known. In general, this element can be recharged by the kinetic energy of the vehicle via the power train or by a generator driven by a combustion engine, or by electrical recharging starting from the power supply grid. The storage element is in general a battery of chemical accumulators. Therefore, a certain number of hybrid and electrical vehicles are recharged starting from an electrical network such as the EDF grid which delivers an alternating voltage of 220V. This type of recharging requires the availability of a charger that adapts the voltage level of the EDF sector to the required recharging voltage of the batteries. This type of charger is a heavy, complex and costly piece of equipment.

In addition, in order to increase the storage capacity and to meet the increasing demands of vehicles, the electrical supply system was equipped with a second storage system with a different storage capacity than the first storage system. This second storage element is in general a supercapacitor.

In general, in the on-board electrical network of an automotive vehicle the nominal voltage at the terminals of the supercapacitor can vary for instance from 0V to 300V, while the nominal voltage at the battery terminals is 100V.

In this way, an overall network of dual voltage electrical power supply is obtained. The two storage elements are connected with each other through the intermediary of a direct-direct voltage converter (or DC-DC converter). The purpose of this converter is to allow transfer of electrical energy between the two storage elements in function of the electrical requirements of the different components and accessories of the vehicle.

There is however a problem of pre-charging or initial charging when the voltage of the supercapacitors is lower than the battery voltage.

In general, outside the working domain of the converter it is not possible to charge this second element starting from the DC-DC converter. However, when this second element is charged directly starting from a higher voltage source, it becomes necessary to limit the charge current of this second element, since a very significant current draw can occur.

### BRIEF SUMMARY

Therefore, the goal of the present invention is to propose a recharging device for a storage system comprising two storage elements with different continuous nominal voltages starting from an electrical power supply network, which does not require the addition of a specific charger and consequently is simpler to implement and less costly relative to known recharging devices.

For this purpose, the invention relates to a recharging device for a storage system of electrical energy starting from an electrical power supply network, said storage system is used as a supply source for electrical or hybrid automotive vehicles, said system comprising:
first storage element of electrical energy, specifically a battery and a second storage element of electrical energy, specifically a supercapacitor pack,
direct-direct electrical converter arranged between said first element and second element, said first element having a first continuous voltage, and said second element having a second continuous voltage likely to exceed said first voltage.

According to the invention, the recharging system comprises:
voltage rectifier device connected on one side through an electrical connection to the side of the converter which is connected to the second element, and connected on the other side to the supply network through a removable electrical connection, said device is suitable for rectifying the alternating voltage supplied by the network in a continuous voltage in the functional range of said converter, and furthermore
means for controlling the charge current of said second element, said control means are arranged between the converter and the second element.

According to one implementation mode, the control means comprises an isolating switch which when activated allows for electrical isolation of said second element from the converter during the charging of the first element.

By preference, this isolating switch can be an electromechanical relay or an electronic commutation system.

According to one implementation mode, said control means comprises a pre-charging device which allows for control of the voltage applied to said second storage element in such manner as to limit the charge current of said second storage element. By preference, this pre-charging device is formed by an electrical dipole with variable transconductance.

By preference, this electrical dipole consists of a resistor and a relay or a transistor of which the transconductance is controlled by means of the appropriate tension on its control pin.

By preference, the rectifying device consists of a single phase or three phase diode bridge.

The invention relates furthermore to a method for using the recharging device according to the invention in which the rectifying device is used to transform the alternating (AC) voltage delivered by the network into a continuous voltage and to modify its value so that it falls in the working range of said converter and the converter is arranged between the first storage element and the control means used to control the charging of said first element.

According to one implementation mode, to recharge the storage system through the supply network used in the recharging device according to the invention equipped with an isolating switch arranged between the second element and the converter,
the rectified voltage supplied by the rectifying device is applied to the terminals of the converter, said converter transfers the electrical energy towards the first element while adapting the level of the applied voltage to make it compatible with the recharging voltage range of the first element, and in a concomitant manner,
the isolating switch, arranged between said second element and the converter, is activated in order to electrically isolate the second element during the recharging of the first element.

According to another implementation mode, to recharge the storage system through the supply network used in the recharging device according to the invention equipped with a pre-charging device arranged between the second element and the converter,
when the charging voltage of the second element is lower than the rectified voltage supplied by the rectifying device, the pre-charging device is turned on in order to perform a pre-charge of the second element until the voltage at the terminals of the second element and the rectified voltage are equalized, and the direct-direct converter is turned off during the pre-charging of the second element,
when the charge voltage of the second element is greater than or equal to the rectified voltage supplied by the rectifying device, the pre-charging device is turned off, and the direct-direct converter is turned on to charge directly the first element.

### BRIEF DESCRIPTION OF THE FIGURES

The invention will be better understood by reading the description which follows and by examining the accompanying figures. These figures are given only as non limiting illustrations of the invention. They show:

FIG. 1: a schematic representation of a recharging device according to a first implementation mode of the invention comprising an isolating switch;

FIG. 2: a schematic representation of a recharging device according to a second implementation mode of the invention comprising a pre-charging device.

### DETAILED DESCRIPTION

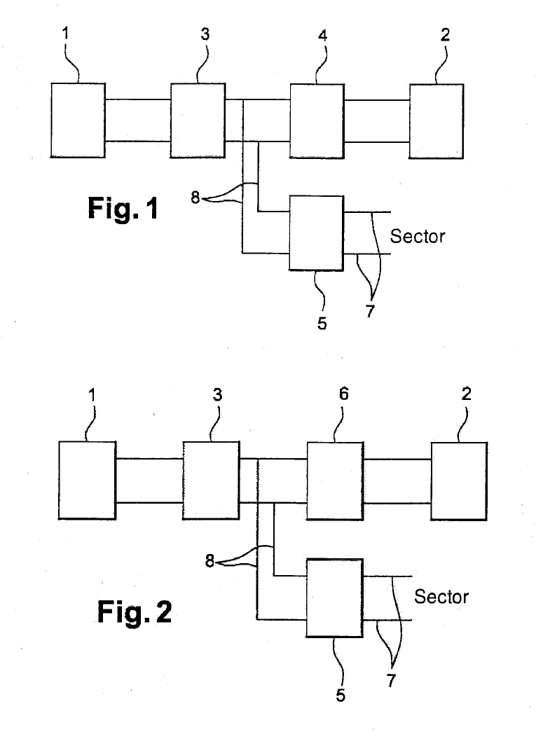

FIG. 1 and FIG. 2 show schematically the architecture of a storage system for electrical energy comprising a first storage element of electrical energy consisting of a battery 1 associated to a second storage element of electrical energy consisting of a pack of supercapacitors 2.

In general manner, in the on-board electrical network of an automotive vehicle, the continuous nominal voltage at the terminals of the supercapacitor can vary, for example, from 0V to 300V, while the voltage at the terminals of the battery is approximately 100V.

A DC-DC converter 3 is arranged between the storage elements 1, 2 to ensure transfer of energy between the two elements.

FIG. 1 shows a recharging device according to a first implementation mode of the invention intended to recharge the storage system starting from an electrical grid EDF. The recharging device comprises a rectifying device 5 which rectifies the alternating voltage supplied by the grid in a continuous voltage within the working range of the DC-DC converter. This device is connected on one side to the alternating grid by a removable electrical connection 7, and on the other side by a fixed electrical connection 8 to the terminals of an electrical converter 3 on the side where the converter 3 is connected to the second element 2.

Advantageously, such recharging device 5 can recharge the first element 1 without requiring the addition of a charger, by connecting it to a domestic electrical

Furthermore, the recharging device 5 comprises an isolating switch 4 which is intended for electrically isolating the second storage element 2 from the rest of the storage system during the recharging of the first storage element 1. This isolating switch 4 is arranged between the DC-DC converter 3 and the second element 2. The purpose of this isolating switch is to suppress the problem of the initial charging of the second element, which occurs when it involves charging this capacity outside the working domain of the DC-DC converter 3.

The solution proposed here consists in electrically isolating the second element 2 during the recharging of the first element 1, and because of this, when the rectifying device 5 is connected to the network the charge current does not circulate to the second element.

The working principle of the recharging device shown in FIG. 1 is the following. When the first element 1 needs recharging, the rectifying device 5 is connected to the network. The rectified voltage supplied by the rectifying device is applied directly to converter 3 which then transfers the electrical energy to the first element 1. The converter adapts the level of the rectified voltage in order to make it compatible with the recharging voltage domain of the first element. Simultaneously, the isolating switch 4 is activated so that it is in open state, in this way the second element 2 is isolated from converter 3 during the recharging of the first element 1.

Once the recharging is completed, the rectifying device is disconnected from the network, and the isolating switch is deactivated automatically so that it is in closed state, reestablishing the connection between converter 3 and second element 2 in order to make the storage system functional.

By preference, the rectifying device 5 consists of a single phase diode bridge or a three phase diode bridge in case recharging takes place in a three phase network.

By preference, the isolating switch 4 consists of an electromechanical relay or an electronic commutation system such as a transistor. The alternating opening and closing of this isolating switch is commanded by means of appropriate signals.

The recharging device according to the first implementation mode does not allow recharging the second element 2 starting from the grid, if needed.

FIG. 2 shows a recharging device according to a second implementation mode of the invention capable not only of recharging the first element 1 starting from the supply network but also of pre-recharging the second element 2 while controlling its charge current. For this purpose, the recharging device shown in FIG. 2 comprises in addition a pre-charging device 6 arranged between the converter 3 and the second element 2 which is turned on during pre-charging.

During pre-charging, the converter 3 is not utilized. The second element 2 is supplied by the rectified voltage via the pre-charging device 6 of which the output voltage is controlled in order to limit the instantaneous charge current. When the voltage at the terminals of the second element 2 reaches the value of the rectified voltage, the pre-charging device 6 is placed in a state in which it presents the weakest possible resistance to the circuit in order not to restrain the current.

The DC-DC converter 3 is then put back into service to recharge the first element 1.

By preference, this pre-charging device 6 consists of an electrical dipole with variable transconductance. As an example, it can be formed by a resistor and a relay with the contact placed downstream of the terminals of the resistor or by a transistor with transconductance modulated by a voltage signal.

The working principle of this second implementation mode of the invention differs from the first in that it allows pre-charging of the second element 2 when the latter has a voltage lower than the rectified voltage supplied by the network.

When the charge voltage of the second element 2 is lower than the rectified voltage supplied by the rectifying device 5, the pre-charging device 6 is turned on in order to pre-charge the second element 2 until the voltage at the terminals of the second element 2 and the rectified voltage are equalized, and the direct-direct converter 3 is turned off during the pre-charging of the second element 2. When the voltage at the terminals of the converter 3 reaches the rectified voltage, the converter 3 is turned back on to charge the first element.

Advantageously, when the charge voltage of the second element 2 is greater than or equal to the rectified voltage delivered by the rectifying device 5, the pre-charging device is turned off, and the direct-direct converter 3 is turned on directly to charge the first element 1.

1. A recharging device for a storage system of electrical energy starting from an electrical power supply network, said storage system being used as supply source for electrical or hybrid automotive vehicles, said system comprising:
a first storage element for electrical energy, specifically a battery, and a second storage element for electrical energy, specifically a pack of supercapacitors,
a DC-DC converter arranged between said first element and second element, said first element presenting a first continuous service voltage, and said second element presenting a second continuous voltage likely to exceed said first voltage,
a voltage rectifying device connected on one side by an electrical connection to the converter on the side where the converter is connected to the second element, and connected on the other side by a removable electrical connection to the supply network, said rectifying device being suitable to rectify an alternating voltage supplied by the network into a continuous voltage in the working range of said converter, and
control means for controlling the charge current of said second element, said control means being arranged between the converter and the second element.

2. The recharging device according to claim 1, wherein said control means comprises an isolating switch, which when activated electrically isolates the second element from the converter during charging of the first element.

3. The recharging device according to claim 2, wherein said isolating switch is an electromechanical relay or an electronic commutation system.

4. The recharging device according to claim 1, wherein said control means comprises a pre-charging device, which when active controls the voltage applied to the second storage element so as to limit the charge current of said second storage element.

5. The recharging device according to claim 4, wherein said pre-charging device comprises an electrical dipole with variable transconductance.

6. The recharging device according to claim 5, wherein said electrical dipole comprises a resistor and a relay or a transistor of which the transconductance is controlled by means of appropriate voltages on its control pin.

7. The recharging device according claim 1 wherein said rectifying device comprises a single phase or three phase diode bridge.

8. A method for using the recharging device for recharging the storage system starting from the electrical supply network, the recharging device comprising:
a first storage element for electrical energy, specifically a battery, and a second storage element for electrical energy, specifically a pack of supercapacitors,
a DC-DC converter arranged between said first element and second element, said first element presenting a first continuous service voltage, and said second element presenting a second continuous voltage likely to exceed said first voltage,
a voltage rectifying device connected on one side by an electrical connection to the converter on the side where the converter is connected to the second element, and connected on the other side by a removable electrical connection to the supply network, said rectifying device being suitable to rectify an alternating voltage supplied by the network into a continuous voltage in the working range of said converter, and
control means for controlling the charge current of said second element, said control means being arranged between the converter and the second element;
the method comprising:
rectifying the alternating voltage supplied by the network into a continuous voltage in the working range of said DC-DC converter using the voltage rectifying device which is connected on the one side by a removable electrical connection, and
controlling the charging of the first storage element using the DC-DC converter, which is arranged between the first storage element and the control means.

9. The method according to claim 8, wherein the control means comprises an isolating switch, which when activated electrically isolates the second element from the DC-DC converter during charging of the first element; the method comprising
supplying rectified voltage from the rectifying device to the input terminals of the converter, transferring the electrical energy from said DC-DC converter to the first element while adapting the applied voltage level in order to make it compatible with the charge voltage range of the first element, and in a concomitant manner,
activating the isolating switch, which is arranged between said second element and the converter, in order to electrically isolate the second element during recharging of the first element.

10. The method according to claim 8 wherein said control means comprises a pre-charging device, which when active controls the voltage applied to the second storage element so as to limit the charge current of said second storage element; the method comprising
activating the pre-charging device when the charging voltage of the second element is lower than the rectified voltage supplied by the rectifying device so that pre-charging of the second element takes place until the voltage at the terminals of the second element and the rectified voltage are equalized and the DC-DC converter is turned off during pre-charging of the second element,
deactivating the rectifying device when the charging voltage of the second element is greater than or equal to the rectified voltage supplied by the rectifying device, and activating the DC-DC converter to directly charge the first element.
